(19) United States
(12) Patent Application Publication
(10) Pub. No.: US 2014/0359066 A1
(43) Pub. Date: Dec. 4, 2014

(54) SYSTEM, METHOD AND DEVICE FOR OFFLINE DOWNLOADING RESOURCE AND COMPUTER STORAGE MEDIUM

(71) Applicant: TENCENT TECHNOLOGY (SHENZHEN) COMPANY LIMITED, Shenzhen (CN)

(72) Inventors: Gang LIU, Shenzhen (CN); Chenyuan ZHU, Shenzhen (CN); Hang YIN, Shenzhen (CN)

(21) Appl. No.: 14/459,509

(22) Filed: Aug. 14, 2014

Related U.S. Application Data
(63) Continuation of application No. PCT/CN2012/087136, filed on Dec. 21, 2012.

(30) Foreign Application Priority Data
Feb. 14, 2012 (CN) 201210032600.7

(51) Int. Cl. H04L 29/08

(52) U.S. Cl. CPC H04L 67/06
USPC 709/217

(57) ABSTRACT

A seed file server for resources is set in a system for offline downloading resources. The seed file server may include a seed file access service unit, a seed file database unit and a seed crawler unit. The seed file access service unit is configured to obtain a seed file of a resource from a client, and transmit the seed file to the seed file database unit to be stored. The seed crawler unit is configured to obtain a seed file of a resource from the Internet, and store the seed file in the seed file database unit. When to download the resource, an offline download server obtains the seed file corresponding to the resource directly from the seed file database unit, and downloads the resource from the Internet based on the seed file.

### CROSS REFERENCE TO RELATED APPLICATIONS

This application is a continuation of International Patent Application Number PCT/CN2012/087136, filed on Dec. 21, 2012, which claims priority to a Chinese patent application No. 201210032600.7, filed on Feb. 14, 2012, where the content of both of said applications are herein incorporated herein by reference in their entirety.

### TECHNICAL FIELD

The present disclosure relates to data download technologies of computer field, and more particularly, to a system, method and device for offline downloading data.

### BACKGROUND

With the development of Internet technologies, more and more services may be implemented in the Internet. Among these services, a download service refers to that a client downloads resources from the Internet. The download service may be divided into an offline resource download service and an online resource download service depending on different types of download. The offline download service is that a server-side in the Internet downloads a resource that a client requires for the client firstly, and then the client downloads the required resource from the server-side. For example, a certain resource is unpopular, and a client can download it at a very slow speed. Thus, it will take a long time for the client to download the resource. It is time-consuming and laborious. In such a case, the client may use an offline download method. That is, a server-side downloads the resource for the client. The client may be shut down, and download the resource from the server-side after the server-side has downloaded the resource completely. Thereby, time and download costs are saved.

### SUMMARY

In view of above, an example of the present disclosure provides a system for offline downloading resources, which may obtain a seed file corresponding to resource before offline downloading the resource, so as to offline download the resource.

An example of the present disclosure also provides a method for offline downloading resources, which may obtain a seed file corresponding to resource before offline downloading the resource, so as to offline download the resource.

An example of the present disclosure also provides a device for offline downloading resources, which may obtain a seed file corresponding to resource before offline downloading the resource, so as to offline download the resource.

To achieve the above objectives, the technical solutions of the present disclosure may be implemented as follows.

A system for offline downloading resources, in which the system includes a seed file server, a client and a group of offline download servers,

the client is configured to transmit a request for downloading a resource;

the seed file server is configured to obtain a seed file corresponding to the resource and store the seed file; and

the group of offline download servers is configured to receive the request for downloading the resource, read from the seed file server the seed file corresponding to the resource, and download the resource based on the seed file;

wherein the seed file corresponding to the resource is an uploaded seed file obtained from the client, or a seed file obtained from the Internet, or a combination of the uploaded seed file obtained from the client and the seed file obtained from the Internet.

The seed file server includes a seed file access service unit, a seed crawler unit and a seed file database unit, wherein

the seed file access service unit is configured to obtain the uploaded seed file from the client, and then transmit the seed file to the seed file database unit to be stored;

the seed crawler unit is configured to obtain the seed file corresponding to the resource from the Internet, and transmit the seed file to the seed file database unit to be stored; and

the seed file database unit is configured to store the seed file from the seed file access service unit, and the seed file from the seed crawler unit.

The seed file access service unit is further configured to receive a query request from the client, query a corresponding seed file in the seed file database unit, and provide the corresponding seed file queried to the client for display, or

the seed file access service unit is further configured to receive a request for downloading a seed file from the client, download the corresponding seed file from the seed file database unit, and provide the corresponding seed file downloaded for the client to be downloaded, or

the seed file access service unit is further configured to receive the query request and the request for downloading the seed file from the client, query and download the corresponding seed file from the seed file database unit, provide the corresponding seed file queried to the client for display, and provide the corresponding seed file downloaded for the client to be downloaded.

The system further includes a cloud storage server, and the cloud storage server is configured to store a resource, which has been downloaded completed by the group of offline download servers, and provide the resource to a corresponding client to be downloaded.

A method for offline downloading resources, which includes:

storing a seed file corresponding to a resource at a server-side, wherein the method further includes:

receiving, by the server-side, a request for downloading the resource from a client, reading the seed file corresponding to the resource stored at the server-side, and downloading the resource based on the seed file.

The seed file corresponding to the resource stored at the server-side is a seed file obtained from the client, or a seed file obtained from the Internet, or a combination of the seed file obtained from the client and the seed file obtained from the Internet.

The method further includes:

storing the resource downloaded at the server-side, and providing the resource downloaded to the corresponding client to be downloaded.

The method further includes:

receiving, by the server-side, a query request from the client, querying a corresponding seed file, and providing the corresponding seed file queried to the client for display, or

receiving, by the server-side, a request for downloading a seed file from the client, downloading the corresponding seed file, and providing the corresponding seed file downloaded for the client to be downloaded, or

receiving, by the server-side, the query request and the request for downloading the seed file from the client, querying and downloading the corresponding seed file, providing the corresponding seed file queried to the client for display, and providing the corresponding seed file downloaded for the client to be downloaded.

An offline download seed server, which includes a memory, a processor in communication with the memory, and an interface, wherein the memory stores a seed file access service instruction, a seed file database instruction and a seed crawler instruction, which are executable by the processor, wherein

the seed file access service instruction indicates to obtain an uploaded seed file from a client,

the seed crawler instruction indicates to obtain a seed file corresponding to a resource from the Internet, and

the seed file database instruction indicates to store the seed file received based on the seed file access service instruction, and the seed file received based on the seed crawler instruction.

The seed file access service instruction further indicates to receive a query request from the client, query a corresponding seed file, and provide the corresponding seed file queried to the client for display,

or, the seed file access service instruction further indicates to receive a request for downloading a seed file from the client, download the corresponding seed file, and provide the corresponding seed file downloaded for the client to be downloaded;

or, the seed file access service instruction further indicates to receive the query request and the request for downloading the seed file from the client, query and download the corresponding seed file, provide the corresponding seed file queried to the client for display, and provide the seed file downloaded for the client to be downloaded.

As can be seen from the above technical solutions, based on an example of the present disclosure, a seed file server for resources is set in a system for offline downloading resources. The seed file server for resources may include a seed file access service unit, a seed file database unit and a seed crawler unit. The seed file access service unit is configured to obtain a seed file of a resource from a client, and then transmit the seed file to the seed file database unit, so as to store the seed file. The seed crawler unit is configured to obtain a seed file of a resource from the Internet, and store the seed file in the seed file database unit. When an offline download server is to download a resource, the offline download server may obtain the seed file corresponding to the resource directly from the seed file database unit, and download the resource from the Internet based on the seed file. Thus, the system, method and device provided by the present disclosure may obtain the seed file corresponding to the resource before offline downloading the resource, so as to offline download the resource.

### BRIEF DESCRIPTIONS OF THE DRAWINGS

FIG. 1 is a schematic diagram illustrating structure of a system for offline downloading resources.

FIG. 2 is a schematic diagram illustrating structure of a system for offline downloading resources, in accordance with an example of the present disclosure.

FIG. 3 is a flowchart illustrating a method for offline downloading resources, in accordance with an example of the present disclosure.

FIG. 4 is a schematic diagram illustrating structure of a seed file server, in accordance with an example of the present disclosure.

FIG. 5 is a schematic diagram illustrating another structure of a seed file server, in accordance with an example of the present disclosure.

### DETAILED DESCRIPTIONS

To make objectives, technical solutions and advantages of the present disclosure clearer, detailed descriptions about the present disclosure will be further provided in the following, accompanying with attached figures and specific examples.

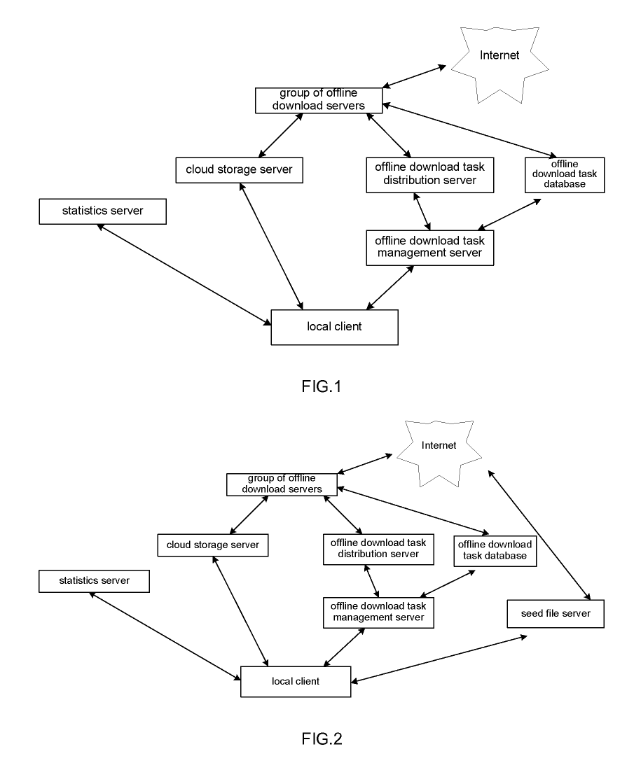

FIG. 1 is a schematic diagram illustrating structure of a system for offline downloading resources. The system for offline downloading resources may include a server-side and a client. Specifically speaking, the server-side may include a group of offline download servers, a cloud storage server, an offline download task distribution server, an offline download task management server, an offline download task database and a statistics server.

The client is configured to transmit a request for downloading a resource to the offline download task management server. The request for downloading a resource carries information of a link to the resource to be downloaded, so as to acquire the resource to be downloaded from the cloud storage server.

The offline download task management server is configured to receive the request for downloading a resource transmitted by the client, and query in the offline download task database whether there is a record for the request for downloading a resource and the download state is “downloaded completely”. If yes, the offline download task management server may notify the client to acquire the resource to be downloaded from the cloud storage server directly. Otherwise, the offline download task management server may transmit the information of a link to the resource to be downloaded carried by the request for downloading a resource to the offline download task distribution server, and store the record for the request for downloading a resource and a download state of “not downloaded” in the offline download task database.

The offline download task distribution server is configured to receive the information of a link to the resource to be downloaded carried by the request for downloading a resource, distribute downloading of the resource to be downloaded according to loads in the group of offline download servers, and instruct the group of offline download servers to download the resource to be downloaded from the Internet.

The group of offline download servers is configured to link to the Internet, based on the information of a link to the resource to be downloaded carried by the request for downloading a resource, under the instruction of the offline download task distribution server, download the resource to be downloaded, and then store the resource downloaded in the cloud storage server, and modify the download state of the record for the request for downloading a resource stored in the offline download task database as “downloaded completely”.

The offline download task database is configured to store a record for a request for downloading a resource and a download state.

The cloud storage server is configured to store resources to be downloaded.

The statistics server is configured to monitor a client and make a statistics on relevant information of the client.

A client may transmit a request for downloading a resource to the offline download task management server in the system. The information of a link to the resource to be downloaded carried by the request for downloading a resource may be a hypertext transfer protocol (HTTP) link, an eMule link or BitTorrent (Bt) download link, or a hash distribution (MagNent) protocol based link to the resource to be downloaded. When to transmit the information of a link to the resource to be downloaded carried by the request for downloading a resource to the offline download task distribution server, the offline download task management server may transmit the uniform resource locator (URL) of the http link if the information of a link is an http link. The offline download task management server may transmit information of a seed file of the eMule link or the Bt download link, if the information of a link is an eMule link or a Bt download link.

In the system, the client may acquire a resource to be downloaded from the cloud storage server in a peer to server and to peer (P2SP) manner, and the group of offline download servers may also download a resource to be downloaded from the Internet in the P2SP manner. In addition, an offline download server may also transmit a download progress and a current download state of the record of the request for downloading a resource to the offline download task management server via the offline download task distribution server.

Offline downloading a resource by using the above system has been widely used. It has the following features.

1) Downloading of unpopular resources is speeded up. The offline downloading of resources solves the problem that unpopular resources are downloaded slowly and a client needs to link to the Internet for a long time. By using a large bandwidth of the server-side, the unpopular resources may be downloaded to the server-side firstly and then to a local client. Thereby, time and download costs of the client are saved.

2) A speed of downloading resources is improved stably. By using the offline downloading of resources, a faster and more stable speed is achieved. The server-side provides a stable download speed for the client, which differs from the following scenario. When resources are downloaded online and the client links to the Internet directly, and thereby a download speed is affected by an environment of the Internet and is unstable.

3) The problems of network blocking and a limited network are solved. Even if use of a BT download manner or an eMule download manner by the client is limited, the client may also acquire a resource to be downloaded from the server-side with a higher download efficiency by using the manner of the offline downloading of resources.

When linking to the Internet to download a resource to be downloaded, the group of offline download servers of the server-side may download the resource, by using the BT download manner or the Magnent protocol based manner. In such cases, a seed file is necessary. The BT downloading is based on a resource distribution protocol, uses an efficient resource distribution system and shares resources with a peer to peer technique, such that entities in the Internet may upload resources. Based on the Bt download manner, a resource distributor may generate a seed file for a resource. The seed file is essentially a text file, which includes information of a tracker server and resource information. The information of a tracker server may include address information and setting information of the tracker server. The resource information may include index information and a hash verification code of each virtual block divided for the resource. Thus, the seed file is indexes of the resource and the resource may be acquired based on the seed file.

When the BT downloading is employed, the offline download server firstly needs to acquire a seed file for a resource to be downloaded from a tracker server or from other servers. Then, the offline download server may parse the seed file and link to the tracker server, based on acquired information of the tracker server. Subsequently, the tracker server may respond to the offline download server, and provide information about a link to an entity currently having the resource corresponding to the seed file in the Internet. Finally, the offline download server may link to the entity currently having the resource corresponding to the seed file, determine each divided virtual block based on file information in the seed file, and receive a virtual block not possessed by the offline download server from the entity currently having the resource corresponding to the seed file, thereby acquiring the complete resource. During this process, a service of a tracker server or other servers is no longer necessary. Thus, bandwidths in the Internet may be dispersed and burdens on servers in the Internet may be reduced.

When the Magnent protocol based manner is employed to download, a seed file for a resource may not be stored in a tracker server or other servers. A digital fingerprint to uniquely identify a resource is obtained for each resource after calculating with the Hash algorithm. The offline download server may link to an entity having the resource via the Internet based on the digital fingerprint, thereby acquiring a seed file corresponding to the resource stored by the entity. That is, the seed file may be acquired in a distributed manner.

Whether downloading is executed by using the Bt download or in the Magnent protocol based manner, the offline download server needs to acquire a seed file for a resource. The offline download server may start offline downloading of the resource based on the seed file. Thus, how to enable the offline download server to acquire a seed file for a resource becomes a key problem for offline downloading the resource.

During the process of offline downloading a resource, to enable an offline download server in a group of offline download servers to acquire a seed file corresponding to the resource, before offline downloading the resource, so as to implement the offline downloading of the resource, in accordance with an example of the present disclosure, a seed file server for resources is set in a system for offline downloading resources. The seed file server for resources may include a seed file access service unit, a seed file database unit and a seed crawler unit. The seed file access service unit is configured to obtain a seed file of a resource from a client, and then transmit the seed file to the seed file database unit, so as to store the seed file. The seed crawler unit is configured to obtain a seed file of a resource from the Internet, and store the seed file in the seed file database unit. When to download a resource, the offline download server may obtain the seed file corresponding to the resource directly from the seed file database unit, and download the resource from the Internet based on the seed file.

FIG. 2 is a schematic diagram illustrating structure of a system for offline downloading resources, in accordance with an example of the present disclosure. As shown in FIG. 2, the system for offline downloading resources may include a client and a server-side. Specifically speaking, the server-side may include a group of offline download servers, a cloud storage server, an offline download task distribution server, an offline download task management server, an offline download task database, a statistics server and a seed file server for resources.

The seed file server is configured to acquire a seed file of information about a link to a corresponding resource from the client or the Internet and store the seed file.

The client is configured to transmit the seed file for a resource to the seed file server, and transmit a request for downloading a resource to the offline download task management server. The request for downloading a resource may carry information of a link to the resource to be downloaded, so as to acquire the resource to be downloaded from the cloud storage server.

The offline download task management server is configured to receive the request for downloading a resource from the client, query in the offline download task database whether there is a record for the request for downloading a resource and the download state is “downloaded completely”. If yes, the offline download task management server may notify the client to acquire the resource to be downloaded from the cloud storage server directly. Otherwise, the offline download task management server may transmit the information of a link to the resource to be downloaded, which is carried by the request for downloading a resource, to the offline download task distribution server, and store a record for the request for downloading a resource and a corresponding download state of “not downloaded” in the offline download task database.

The offline download task distribution server is configured to receive the information of a link to the resource to be downloaded, which is carried by the request for downloading a resource, distribute downloading of the resource to be downloaded, based on loads in the group of offline download servers, and instruct the group of offline download servers to download the resource to be downloaded from the Internet.

The group of offline download servers is configured to acquire a seed file corresponding to the information of a link to the resource to be downloaded from the seed file server, under an instruction of the offline download task distribution server, link to the Internet based on the seed file, download the resource to be downloaded, and then store the resource to be downloaded in the cloud storage server, and modify the download state of the record for the request for downloading a resource stored in the offline download task database as “downloaded completely”.

The offline download task database is configured to store a record for a request for downloading a resource and a download state.

The cloud storage server is configured to store resources to be downloaded.

The statistics server is configured to monitor a client and make a statistics on relevant information of the client.

In the system, the seed file server may also acquire a seed file of a corresponding resource from the client or the Internet, and store the seed file. When searching in the seed file server, the group of offline download servers may directly determine a resource, and then search for a corresponding seed file.

Specifically speaking, the seed file server in the system may include a seed file access service unit, a seed file database unit and a seed crawler unit.

The seed file access service unit is configured to obtain a seed file about information of a link to a corresponding resource from the client, and then transmit the seed file to the seed file database unit, so as to store the seed file.

The seed crawler unit is configured to obtain a seed file about information of a link to a corresponding resource from the Internet, and transmit the seed file to the seed file database unit, so as to store the seed file.

The seed file database unit is configured to store the seed file about information of a link to a corresponding resource received from the seed file access service unit, and store the seed file about information of a link to a corresponding resource from the seed crawler unit.

In the system, information of a link to a resource may be information of a link to a seed file corresponding to the resource, or a characteristic value to uniquely identify the resource, e.g., a digital fingerprint, or the resource itself. The information of a link to a resource is not limited herein only if it may uniquely determine the resource.

In the system, the seed file access service unit may also receive a seed file query request for information of a link to a corresponding resource from the client and transmit a query result to the client.

The client is also configured to transmit a seed file query request for information of a link to a corresponding resource to the seed file access service unit and receive the query result.

In the system, the seed file server for resources is also configured to transmit a seed file of information of a link to a corresponding resource to the client.

In the system, the seed file database unit serves a function of buffering a seed file of information of a link to a corresponding resource, which is transmitted by the client via the seed file access service unit during offline downloading, or is downloaded by the seed crawler unit from the Internet.

In the system, the main functions of the seed crawler unit are to download from the Internet a seed file of information of a link to a corresponding resource, and store the downloaded seed file in the seed file database unit.

In the system, the main functions of the client may include an offline download function and an online download function.

The offline download function may be implemented as follows. The client transmits a request for downloading a resource to the offline download task management server. The request for downloading a resource may carry information of a link to the resource to be downloaded. Before transmitting the request, the client may query to the seed file access service unit, so as to determine whether a seed file of information of a link to the corresponding resource has been stored in the seed file database unit. If yes, the client may directly make the request. Otherwise, the client may transmit a seed file for the resource to the seed file database unit via the seed file access service unit, so as to store the seed file. The client may acquire the resource to be downloaded from the cloud storage server. During the process of downloading the resource, check is performed when virtual blocks of the resource have been downloaded completely. Upon occurring of an error, the client may report to the statistics server for statistics. Relevant information of the client may be reported to the statistics server after the resource has been downloaded completely. The relevant information of the client may include a download time, a download speed, a download result, a size of the resource, and information of a link to the downloaded resource of downloading the resource this time, download speeds and time of downloading the resource from entities having different virtual blocks of the resource.

The online download function may be implemented as follows. The client may periodically report an online status and a situation of locally available resources to a tracker server, query to a resource index server a set of URLs, a hash value and file check information of a resource to be acquired, through information of a link to the resource to be acquired, and download data to be acquired from the set of URLs. The online download function is in the prior art and thus will not be repeated herein.

In the system, the statistics server is configured to monitor the client, and make a statistics on relevant information of the client. Specifically speaking, the functions of the statistics server may be as follows:

1) receiving error check information of virtual blocks of a resource, that have been downloaded completely and provided by the client during the process of downloading the resource, and a download time, a download speed, a download result, a size of the resource, information of a link to the downloaded resource of downloading the resource this time, as well as download speeds and time of downloading the resource from entities having different virtual blocks of the resource provided when the resource has been downloaded completely, and storing them in a water log format for subsequent statistics and analysis;

2) receiving a query of a hash value of a resource by the client or by the cloud storage server with information of a link to the resource, e.g., a URL;

3) receiving a query of a set of URLs of a resource by the client or by the cloud storage server with information of a link to the resource, e.g., a URL.

The Internet of the system may also include a tracker server, which serves the following main functions: 1) registering the client and feeding back a list of link information about resource entities to be acquired, in which the list of link information is possessed by the client; 2) receiving an online status report transmitted by the client, generating a list of information of a link to an entity having a respective resource, and feeding back a list of information of a link to a corresponding entity when downloading a resource; 3) receiving an Internet-side-synchronized online control strategy for entities, and issuing the online control strategy to a corresponding entity, when the corresponding entity links to the tracker server.

In the system, in addition to acquiring a seed file corresponding to information of a link to a resource to be downloaded from the seed file server, under an instruction of the offline download task distribution server, the group of offline download servers may link to the Internet based on the seed file, download the resource to be downloaded, and then store the resource to be downloaded in the cloud storage server, and modify the download state of the record for the request for downloading a resource stored in the offline download task database as “downloaded completely”. The group of offline download servers may also report information of a progress and a speed of offline downloading to the offline download task database, provide a service support for retrieving a result of the offline downloading from the cloud storage server by the client, when the offline downloading has been completed, download a resource of the client by using a reserved bandwidth, and store a hash result of an offline downloaded resource in the offline download task database.

In the system, the offline download task distribution server is also configured to receive the information of a progress and a speed reported by the group of offline download servers, report the information of a progress to the offline download task management server, filter same requests for offline downloading a resource, such that a same request for offline downloading a resource needs to be transmitted to the group of offline download servers once, and different clients may share the offline download progress and the resource having been offline downloaded completely of a same task.

In the system, the offline download task management server may also generate a unique identification number for each offline download request, and interact with the offline download task database. The offline download task management server may directly notify the client that the offline downloading is successful, when finding that there is a downloaded resource. The offline download task management server may provide information of a link to download the resource from the cloud storage server for the client, when the client is to retrieve the resource having been offline downloaded completely.

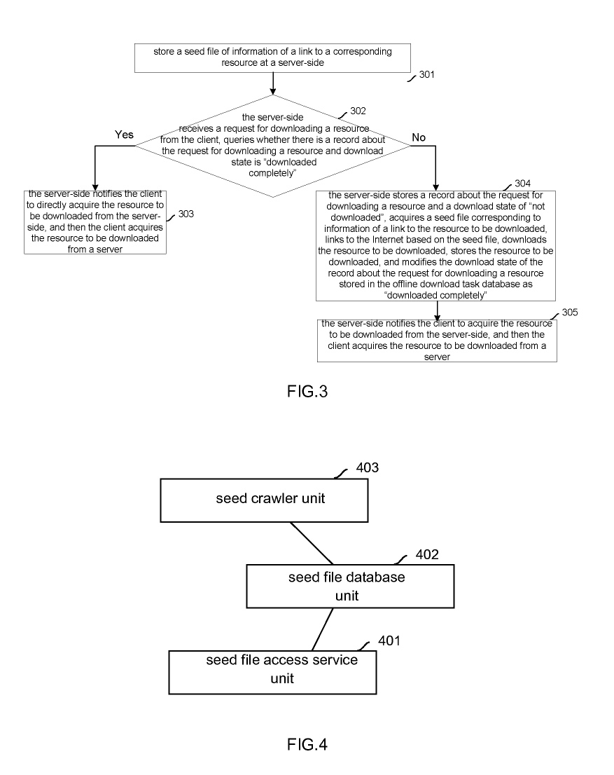

FIG. 3 is a flowchart illustrating a method for offline downloading resources, in accordance with an example of the present disclosure. The method may include the following blocks.

In block 301, a seed file of information of a link to a corresponding resource is stored at a server-side.

In block 302, the server-side may receive a request for downloading a resource from a client, and query whether there is a record about the request for downloading a resource and the download state is “downloaded completely”. If yes, proceed with block 303; otherwise, proceed with block 304.

In block 303, the server-side may notify the client to directly acquire the resource to be downloaded from the server-side, and then the client may acquire the resource to be downloaded from a server.

In block 304, the server-side may store a record about the request for downloading a resource and a download state of “not downloaded”, acquire a seed file corresponding to information of a link to the resource to be downloaded, link to the Internet based on the seed file, download the resource to be downloaded, and then store the resource to be downloaded, and modify the download state of the record about the request for downloading a resource stored in the offline download task database as “downloaded completely”.

In block 305, the server-side may notify the client to acquire the resource to be downloaded from the server-side, and then the client may acquire the resource to be downloaded from a server.

In the method, information of a link to a resource may be link information of a seed file corresponding to the resource, or a characteristic value, which may uniquely identify the resource, e.g., a digital fingerprint.

In the method, a seed file of information of a link to a corresponding resource stored at the server-side may be obtained from the client, or the Internet, or a combination thereof.

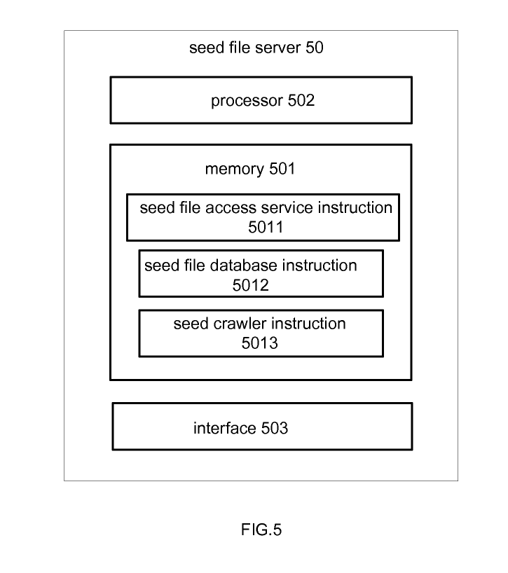

FIG. 4 is a schematic diagram illustrating structure of a seed file server, in accordance with an example of the present disclosure. The seed file server may include a seed file access service unit 401, a seed file database unit 402 and a seed crawler unit 403.

The seed file access service unit 401 is configured to obtain a seed file of information of a link to a corresponding resource from a client, and then transmit the seed file to the seed file database unit 402, so as to store the seed file.

The seed crawler unit 403 is configured to obtain a seed file of information of a link to a corresponding resource from the Internet, and transmit the seed file to the seed file database unit 402, so as to store the seed file.

The seed file database unit 402 is configured to store the seed file of information of a link to a corresponding resource received from the seed file access service unit 401, and the seed file of information of a link to a corresponding resource received from the seed crawler unit 403.

In this example, the seed file access service unit 401 is also configured to receive a query request from the client, query a corresponding seed file in the seed file database unit 402, and provide the queried corresponding seed file to the client for display.

Or, the seed file access service unit 401 is also configured to receive a request for downloading a seed file from the client, download the corresponding seed file from the seed file database unit 402, and provide the corresponding seed file downloaded for the client to be downloaded.

Or, the seed file access service unit 401 is also configured to receive a query request and a request for downloading a seed file from the client, query and download a corresponding seed file in the seed file database unit 402, provide the queried corresponding seed file to the client for display, and provide the downloaded seed file for the client to be downloaded.

As can be seen from the above solutions, in accordance with an example of the present disclosure, a seed file server is introduced into the system of FIG. 1, and a seed file of information of a link to a corresponding resource is stored in the seed file server. In this way, when to offline download a resource, a client may acquire a seed file corresponding to the resource, by providing information of a link to the resource or an identifier to identify the resource, e.g., information of a link to a seed file for the resource, or a characteristic value, which may uniquely identify the resource, rather than by providing a seed file corresponding to the resource. The server-side may link to the Internet based on the seed file, acquire and store the resource. Then, the client may obtain by offline downloading the resource stored at the server-side. In this way, experience of offline downloading of the client may be improved, and an unnecessary seed file of information of a link to a resource is reduced.

An example of the present disclosure also provides a machine-readable storage medium, which may store an instruction to enable a machine to perform a method for offline downloading resources as described herein. Specifically speaking, a system or device with the storage medium may be provided. Software program codes to implement the function of any one of the above examples may be stored in the storage medium, and a computer (a Central Processing Unit (CPU) or a Micro Processor Unit (MPU)) of the system or device may be enabled to read and execute the program codes stored in the storage medium.

In such a case, the program codes read from the storage medium may implement the function of any one of the foregoing examples. Thus, the program codes and the storage medium storing the program codes may constitute a part of the present disclosure.

Examples of the storage medium to provide the program codes may include a floppy disk, a hard disk, a magneto-optical disk, an optical disk (such as a Compact Disc (CD)-Read-only Memory (ROM), a Compact Disk-Recordable (CD-R), a CD-Rewritable (CD-RW), a Digital Versatile Disc (DVD)-ROM, DVD-Random Access Memory (RAM), DVD-RW, and DVD+RW), a magnetic tape, a nonvolatile memory card and an ROM. Alternatively, the program codes may be downloaded from a server computer via a communication network.

Moreover, it should be clear that, part of or all of actual operations may be completed, by executing the program codes read out by the computer, or by an Operating System (OS) operated in the computer, by using an instruction based on the program codes, so as to implement the function of any one of the above examples.

In addition, it may be understood that, the program codes read from the storage medium may be written into a memory set in an expansion board inserted into the computer, or a memory set in an expansion unit connected to the computer, and then part of or all of actual operations may be executed by the CPU, which is installed on the expansion board or the expansion unit, by using an instruction based on the program codes, so as to implement the function of any one of the foregoing examples.

For example, FIG. 5 is a schematic diagram illustrating another structure of a seed file server, in accordance with an example of the present disclosure. As shown in FIG. 5, the seed file server 50 may include a memory 501, a processor 502 in communication with the memory 501 and an interface 503. The memory 501 may store a seed file access service instruction 5011, a seed file database instruction 5012 and a seed crawler instruction 5013, which are executable by the processor 502.

When being executed by the processor 502, the seed file access service instruction 5011 indicates to obtain via the interface 503 a seed file of information of a link to a corresponding resource from a client.

When being executed by the processor 502, the seed crawler instruction 5013 indicates to obtain via the interface 503 a seed file of information of a link to a corresponding resource from the Internet.

When being executed by the processor 502, the seed file database instruction 5012 indicates to store the seed file of information of a link to a corresponding resource received based on the seed file access service instruction 5011, and the seed file of information of a link to a corresponding resource received based on the seed crawler instruction 5013.

Functions implemented by the seed file access service instruction 5011 may be similar to that implemented by the seed file access service unit 401 in the example illustrated in FIG. 4, which will not be repeated here.

The foregoing is only preferred examples of the present disclosure and is not used for limiting the protection scope thereof. Any modifications, equivalent substitutions and improvements made within the spirit and principle of the present disclosure should be covered by the protection scope of the present disclosure.

1. A system for offline downloading resources, wherein the system comprises a seed file server, a client and a group of offline download servers,
the client is configured to transmit a request for downloading a resource;
the seed file server is configured to obtain a seed file corresponding to the resource and store the seed file; and
the group of offline download servers is configured to receive the request for downloading the resource, read from the seed file server the seed file corresponding to the resource, and download the resource based on the seed file;
wherein the seed file corresponding to the resource is an uploaded seed file obtained from the client, or a seed file obtained from the Internet, or a combination of the uploaded seed file obtained from the client and the seed file obtained from the Internet.

2. The system according to claim 1, wherein the seed file server comprises a seed file access service unit, a seed crawler unit and a seed file database unit, wherein
the seed file access service unit is configured to obtain the uploaded seed file from the client, and then transmit the seed file to the seed file database unit to be stored;
the seed crawler unit is configured to obtain the seed file corresponding to the resource from the Internet, and transmit the seed file to the seed file database unit to be stored; and
the seed file database unit is configured to store the seed file from the seed file access service unit, and the seed file from the seed crawler unit.

3. The system according to claim 2, wherein the seed file access service unit is further configured to receive a query request from the client, query a corresponding seed file in the seed file database unit, and provide the corresponding seed file queried to the client for display, or
the seed file access service unit is further configured to receive a request for downloading a seed file from the client, download the corresponding seed file from the seed file database unit, and provide the corresponding seed file downloaded for the client to be downloaded, or
the seed file access service unit is further configured to receive the query request and the request for downloading the seed file from the client, query and download the corresponding seed file from the seed file database unit, provide the corresponding seed file queried to the client for display, and provide the corresponding seed file downloaded for the client to be downloaded.

4. The system according to claim 1, wherein the system further comprises a cloud storage server, and the cloud storage server is configured to store a resource, which has been downloaded completed by the group of offline download servers, and provide the resource to a corresponding client to be downloaded.

5. A method for offline downloading resources, comprising:
storing a seed file corresponding to a resource at a server-side, wherein the method further comprises:
receiving, by the server-side, a request for downloading the resource from a client, reading the seed file corresponding to the resource stored at the server-side, and downloading the resource based on the seed file.

6. The method according to claim 5, wherein the seed file corresponding to the resource stored at the server-side is a seed file obtained from the client, or a seed file obtained from the Internet, or a combination of the seed file obtained from the client and the seed file obtained from the Internet.

7. The method according to claim 5, further comprising:
storing the resource downloaded at the server-side, and providing the resource downloaded to the corresponding client to be downloaded.

8. The method according to claim 5, further comprising:
receiving, by the server-side, a query request from the client, querying a corresponding seed file, and providing the corresponding seed file queried to the client for display, or
receiving, by the server-side, a request for downloading a seed file from the client, downloading the corresponding seed file, and providing the corresponding seed file downloaded for the client to be downloaded, or
receiving, by the server-side, the query request and the request for downloading the seed file from the client, querying and downloading the corresponding seed file, providing the corresponding seed file queried to the client for display, and providing the corresponding seed file downloaded for the client to be downloaded.

9. An offline download seed server, which comprises a memory, a processor in communication with the memory, and an interface, wherein the memory stores a seed file access service instruction, a seed file database instruction and a seed crawler instruction, which are executable by the processor, wherein
the seed file access service instruction indicates to obtain an uploaded seed file from a client,
the seed crawler instruction indicates to obtain a seed file corresponding to a resource from the Internet, and
the seed file database instruction indicates to store the seed file received based on the seed file access service instruction, and the seed file received based on the seed crawler instruction.

10. The offline download seed server according to claim 9, wherein the seed file access service instruction further indicates to receive a query request from the client, query a corresponding seed file, and provide the corresponding seed file queried to the client for display,
or, the seed file access service instruction further indicates to receive a request for downloading a seed file from the client, download the corresponding seed file, and provide the corresponding seed file downloaded for the client to be downloaded;
or, the seed file access service instruction further indicates to receive the query request and the request for downloading the seed file from the client, query and download the corresponding seed file, provide the corresponding seed file queried to the client for display, and provide the seed file downloaded for the client to be downloaded.
